(19) United States
(12) Patent Application Publication
(10) Pub. No.: US 2003/0138274 A1
(43) Pub. Date: Jul. 24, 2003

(54) Image forming apparatus

(75) Inventor: Toshimi Yamashita, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/053,676

(22) Filed: Jan. 24, 2002

(51) Int. Cl. G03G 15/09

(52) U.S. Cl. 399/267; 399/272; 399/273

(57) ABSTRACT

There is disclosed a developing device including a toner hopper, a toner supply source, a toner table on which a toner is laid, an agitator for carrying the toner to the toner table from the toner hopper, a magnet roller disposed above the toner table, a developing sleeve which covers an outer periphery of the magnet roller, holds a magnetic carrier, allows the toner of the toner table to be adsorbed onto the magnetic carrier, and shifts and attaches the toner to an electrostatic latent image of a photosensitive drum, a doctor blade disposed close opposite to the developing sleeve, and a developer returning member which is disposed between the developing sleeve and the toner hopper and is positioned in a position higher than a position of the toner table to prevent the toner cut/removed by the doctor blade from dropping toward the toner hopper and to return the cut/removed toner to the toner table, and which has a tip end displaced toward the developing sleeve from the boundary of the toner table and the toner hopper to form a space for carrying the toner by the agitator between the tip end and the toner table.

### BACKGROUND OF THE INVENTION

The present invention relates to image forming apparatuses such as an electrophotographic copying machine and laser beam printer, and particularly to an improvement in a developing unit which supplies toner to an electrostatic image and develops the electrostatic image.

For a developing device disposed in an image forming apparatus using an electrophotographic process, a two-component developer including a carrier and toner, and one-component developer including only the toner are known.

The two-component developer developing device attaches the toner to particles of a carrier, carries the toner to an outer periphery of a developing sleeve, forms a developer layer on the outer periphery of the developing sleeve, brings the developer layer into contact with the surface of a photosensitive drum (developing roller), and uses a Coulomb force of an electrostatic latent image formed beforehand on the photosensitive drum to detach the toner from the carrier and attach the toner to the electrostatic latent image.

The one-component developer developing device forms a thin layer only of the toner on the outer periphery of the developing sleeve, disposes the photosensitive drum (developing roller) opposite to the developing sleeve at a predetermined interval, selectively supplies the toner to the electrostatic latent image formed on the photosensitive drum, and attaches the toner to the electrostatic latent image.

In recent years, a so-called “pseudotwo-component developing device” using a small amount of a magnetic carrier has been proposed in Jpn. Pat. Appln. KOKOKU Publication Nos. 7-40156 (1995-40156) and 7-43554 (1995-43554). The pseudotwo-component developing device is originally the one-component developing device, but is constituted to attach a start agent (toner including a small amount of the magnetic carrier) to the developing sleeve before starting developing the image and to supply only the toner to the developing sleeve after starting developing the image.

An outline of the pseudotwo-component developing device will be described with reference to FIG. 1. A developing device 10 is used in an image forming apparatus (copying machine) of a vertical sheet conveyance system for conveying a sheet P upwards to the photosensitive drum (not shown). The device also includes a developing sleeve 13 including a magnet roller 12 in order to use the small amount of the magnetic carrier.

A developer carrying mechanism includes a toner hopper 14, agitator 15, and toner table 17 (carrier container 11a). In the developing device 10 of the vertical sheet conveyance system, since the photosensitive drum (not shown) is disposed above the developing sleeve 13, the developer carrying mechanism 11a, 14, 15, 17 cannot be disposed above the developing sleeve 13. Therefore, a toner T is taken up (lifted up) from the toner hopper 14 by the agitator 15, and carried to the developing sleeve 13. A part of the toner T adheres to the developing sleeve 13, and not-adhering remaining toner T returns (drops) to the toner table 17.

When an operation starts, the start agent obtained by mixing the carrier and toner beforehand is supplied to a housing 11. Thereby, since the small amount of magnetic carrier is inserted into the vicinity of the developing sleeve 13, the developing sleeve 13 is replenished only with the magnetic toner from this time on. In order to prevent the magnetic carrier dropping from the developing sleeve 13 from being mixed into the toner hopper 14 in this case, the toner table 17 (carrier container 11a) is disposed right under the developing sleeve 13.

Furthermore, a doctor blade 32 (developer regulating member) is disposed opposite to an outer peripheral surface of the developing sleeve 13, and is constituted to cut/remove surplus toner T from the developing sleeve 13, so that a toner layer having a constant thickness (amount) is formed on the outer peripheral surface of the developing sleeve 13. The surplus toner T cut by the doctor blade 32 is returned to the toner hopper 14, again agitated, and again supplied to the developing sleeve 13.

However, in the conventional developing device 10, when the surplus toner T is returned to the toner hopper 14, toner table 17 (shelf-shaped portion), and developing sleeve 13, particularly to the toner hopper 14, the magnetic carrier is also returned. Therefore, an amount of the magnetic carrier which is originally to be present in the vicinity of the developing sleeve 13 is partially reduced, and a concentration of the toner on the developing sleeve 13 becomes unstable. As a result, image defects such as an image density unevenness, image density dispersion, image density reduction, and fog are possibly generated.

### BRIEF SUMMARY OF THE INVENTION

An object of the present invention is to provide an image forming apparatus in which a concentration of toner on a developing sleeve is stabilized, and an excellent image quality can steadily be obtained over a long period without causing an image density unevenness, image density dispersion, image density reduction, or fog by an unstable toner concentration on the developing sleeve in developing an image with a pseudotwo-component developer.

According to the present invention, there is provided an image forming apparatus including: image reading means for reading an image; a photosensitive drum on which an electrostatic latent image corresponding to the image is formed based on image data given from the image reading means; a vertical conveyance path along which a transfer sheet is conveyed upwards to the photosensitive drum; and a developing device which is disposed below the photosensitive drum and which uses a small amount of magnetic carrier to allow the toner to be adsorbed onto the electrostatic latent image on the photosensitive drum.

The developing device includes:

a toner hopper which contains the toner;

a toner supply source which supplies the toner to the toner hopper;

a toner table which is disposed in a position higher than a position of the toner hopper, which has a boundary adjacent to the toner hopper, and on which the toner is laid;

an agitator which is disposed in the toner hopper, agitates/mixes the contained toner, and carries the toner to the toner table from the toner hopper;

a magnet roller disposed above the toner table;

a developing sleeve which covers an outer periphery of the magnet roller, holds the magnetic carrier, allows the toner of the toner table to be adsorbed onto the magnetic carrier, is rotated/driven in a direction reverse to a rotating/driving direction of the magnet roller, and shifts and attaches the toner to the electrostatic latent image of the photosensitive drum;

a doctor blade which has a tip end disposed close opposite to the developing sleeve at a predetermined interval, and whose tip end cuts/removes a surplus toner from the developing sleeve; and

a developer returning member which is disposed between the developing sleeve and the toner hopper and is positioned in a position higher than a position of the toner table to prevent the toner cut/removed by the doctor blade from dropping toward the toner hopper and to return the cut/removed toner to the toner table, and which has a tip end displaced toward the developing sleeve from the boundary of the toner table and the toner hopper to form a space for carrying the toner by the agitator between the tip end and the toner table.

The toner cut/removed by the doctor blade is inhibited from dropping toward the toner hopper by the developer returning member, and guided and returned to the toner table by the developer returning member. Thereby, the magnetic carrier is prevented from being guided together with the toner and mixed in the toner hopper, and is returned to the developing sleeve via the toner table. Moreover, since the tip end of the developer returning member is displaced toward the developing sleeve from the boundary of the toner table and toner hopper, a space sufficient for carrying the toner from the toner hopper is secured between the tip end and the toner table.

Additionally, the developer returning member is preferably made up of a material by which the carrier and toner T do not cause any frictional charging, an acrylonitrile butadiene styrene (ABS) resin, polycarbonate, or a composite material which contains glass fibers or glass particles in the resin.

Moreover, a member similar to the developer returning member is described in an apparatus of Jpn. Pat. Appln. KOKAI Publication No. 9-197833 (1997-197833) (hereinfafter prior art 1). However, in the apparatus of the prior art 1, a developing unit is disposed substantially at the same height as that of the photosensitive drum, and a sheet is conveyed to the photosensitive drum from the developing unit in a horizontal direction (horizontal sheet conveyance system). Moreover, the apparatus of the prior art 1 is not a pseudotwo-component developer developing device which uses a small amount of magnetic carrier, but is a one-component or genuine two-component developer developing device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an internal sectional view showing a conventional developing device.

FIG. 2A is a characteristic diagram showing a toner concentration distribution on a developing sleeve when the conventional developing device is used to develop an image, and FIG. 2B is a characteristic diagram showing an image density distribution on a hardcopy when the conventional developing device is used to develop the image.

FIG. 3 is an internal sectional view schematically showing a whole image forming apparatus.

FIG. 4 is an enlarged internal sectional view showing a developing unit of the image forming apparatus according to an embodiment of the present invention.

FIG. 5 is a block diagram schematically showing a toner supply section of the developing unit.

FIG. 6 is an enlarged internal sectional view showing a part of the developing unit.

FIG. 7 is an enlarged internal sectional view of a part of another developing unit.

FIG. 8A is a characteristic diagram showing a toner concentration distribution on the developing sleeve when the image forming apparatus of the embodiment of the present invention is used, and FIG. 8B is a characteristic diagram showing an image density distribution on the hardcopy when the image forming apparatus of the embodiment of the present invention is used.

### DETAILED DESCRIPTION OF THE INVENTION

A preferred embodiment of the present invention will be described hereinafter with reference to the accompanying drawings.

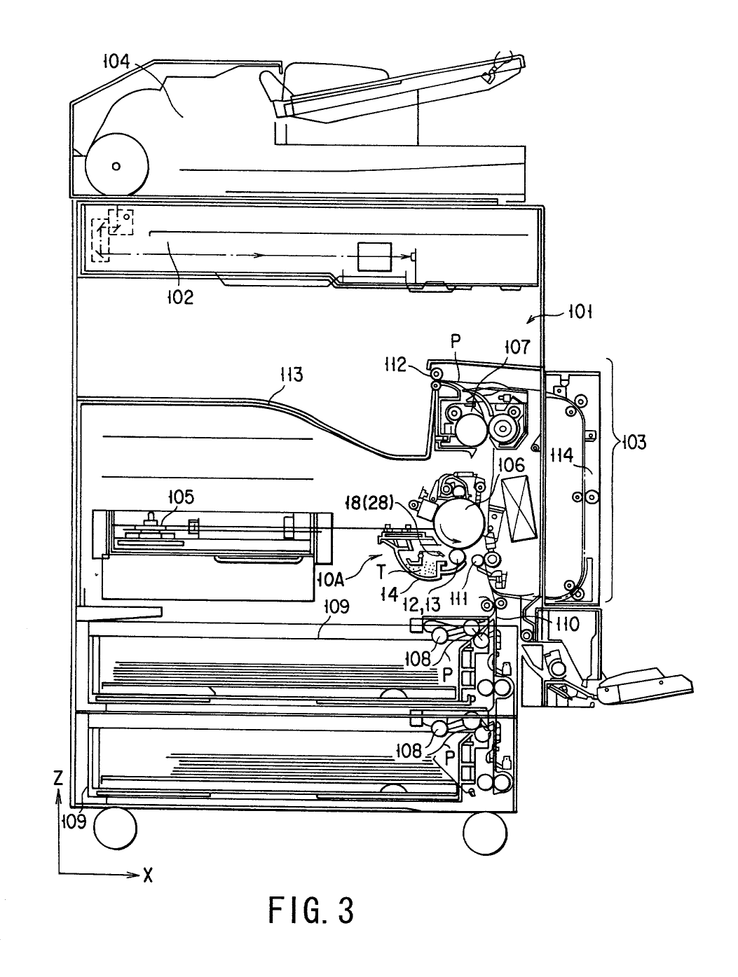

As shown in FIG. 3, a digital copying machine 101 includes a scanner 102 for reading image information of a draft as brightness/darkness of light and generating an image signal, and an image forming section 103 for forming an image corresponding to the image signal supplied from the scanner 102 or an external apparatus (not shown). The scanner 102 includes an automatic draft feeder (ADF) 104 for feeding a sheet-like copy object during an image reading operation by the scanner 102.

The image forming section 103 includes an exposure unit 105, photosensitive drum 106, developing unit 10A, and fixing (heating) unit 107. The exposure unit 105 irradiates the photosensitive drum 106 with a laser beam corresponding to image data supplied from the scanner 102 or the external apparatus (not shown). The photosensitive drum 106 holds the image corresponding to the laser beam from the exposure unit 105 as an electrostatic latent image.

The developing unit 10A includes developing rollers 12, 13 and toner hopper 14 for supplying and attaching a toner to the electrostatic latent image on the photosensitive drum 106. A transfer unit transfers a toner image developed on the photosensitive drum 106 by the developing unit 10A onto a sheet P. The fixing unit 107 heats and melts the transferred toner image, and fixes the image onto the sheet P.

An outline of an operation in the image forming apparatus 101 will next be described.

The sheet P is taken out of a cassette 109 by a pickup roller 108, conveyed along a vertical sheet conveyance path 110, successively passed through the developing unit 10A, photosensitive drum 106, and fixing unit 107, and discharged onto a tray 113 via a discharge roller 112. Additionally, a reference numeral 111 in FIG. 3 denotes an aligning roller whose operation is controlled by a controller (not shown). The aligning roller 111 feeds the sheet P into a transfer position between the photosensitive drum 106 and the transfer unit at a predetermined timing.

The image information is supplied from the scanner 102 or the external apparatus, and the photosensitive drum 106 charged beforehand at a predetermined potential is then irradiated with the laser beam whose strength is modulated in accordance with the image information by the exposure unit 105. Thereby, the electrostatic latent image corresponding to the image to be copied is formed on the photosensitive drum 106.

A toner T is supplied to the photosensitive drum 106 from the developing unit 10A, and the electrostatic latent image is developed. The toner T of the toner image is transferred onto the sheet P by an electric field given from the transfer unit which is not described herein in detail. The transferred toner T on the sheet P is heated/molten in the fixing unit 107, and fixed onto the sheet P.

The developing unit of a first embodiment will next be described with reference to FIGS. 4 to 6.

As shown in FIG. 4, the developing unit 10A includes a housing 11, developing roller (magnet roller 12 and developing sleeve 13), toner hopper 14, agitator 15, toner table 17, developer returning member 18, toner cartridge holder 19, sensor 21, and doctor blade 32. The developing rollers 12, 13 and toner cartridge holder 19 are disposed on opposite sides of the toner hopper 14, and are positioned above the toner hopper 14. The toner hopper 14 and toner table 17 are formed integrally with the housing 11, and constitute a part 11a of the housing 11.

The toner table 17 is disposed in the close vicinity to an upper edge of the toner hopper 14, and disposed to be flat and substantially horizontal. The toner table 17 is positioned right under the developing rollers 12, 13, extends along an axial direction of the developing rollers 12, 13, and is a little longer than the developing rollers 12, 13. A position of the toner table 17 is higher than a position of the toner hopper 14. The toner T is taken up from the toner hopper 14 by the agitator 15, and passes a boundary 17a and rides onto the toner table 17.

The developing rollers 12, 13 are positioned right above the toner table 17, and the photosensitive drum 106 (not shown) is further disposed right above the developing rollers 12, 13. The toner T shifts to the developing sleeve 13 (outer peripheral portion of the developing roller) from the toner table 17, and next shifts to the photosensitive drum 106.

A core of the developing roller is formed of the magnet roller 12, and an outer peripheral portion of the developing roller is formed of the developing sleeve 13. The magnet roller 12 and developing sleeve 13 are coaxially disposed, and the developing sleeve 13 covers the outer periphery of the magnet roller 12. The magnet roller 12 and developing sleeve 13 are independently rotated/driven by a rotating/driving mechanism (not shown).

Additionally, an interval between the outer peripheral surface of the developing sleeve 13 and that of the photosensitive drum 106 in the closest vicinity is set to be substantially 0.35 mm. Moreover, the developing sleeve 13 is rotated in the same direction in a position opposite to the outer peripheral surface of the photosensitive drum 106, and at a movement speed of 254 mm/sec. The developing sleeve 13 has a diameter of 20 mm.

As seen from a transverse section of the magnet roller 12 crossing at right angles to an axis, N and S poles are alternately disposed at a substantially uniform interval in a roller peripheral direction, and twelve poles in total are disposed in this manner. Additionally, a magnetic force of each magnetic pole of the magnet roller 12 is measured on the surface of the developing sleeve 13, and substantially indicates 700 gausses. Moreover, the magnet roller 12 is rotated in a direction reverse to a direction of the developing sleeve 13 at a rotation speed, for example, of 2000 rpm.

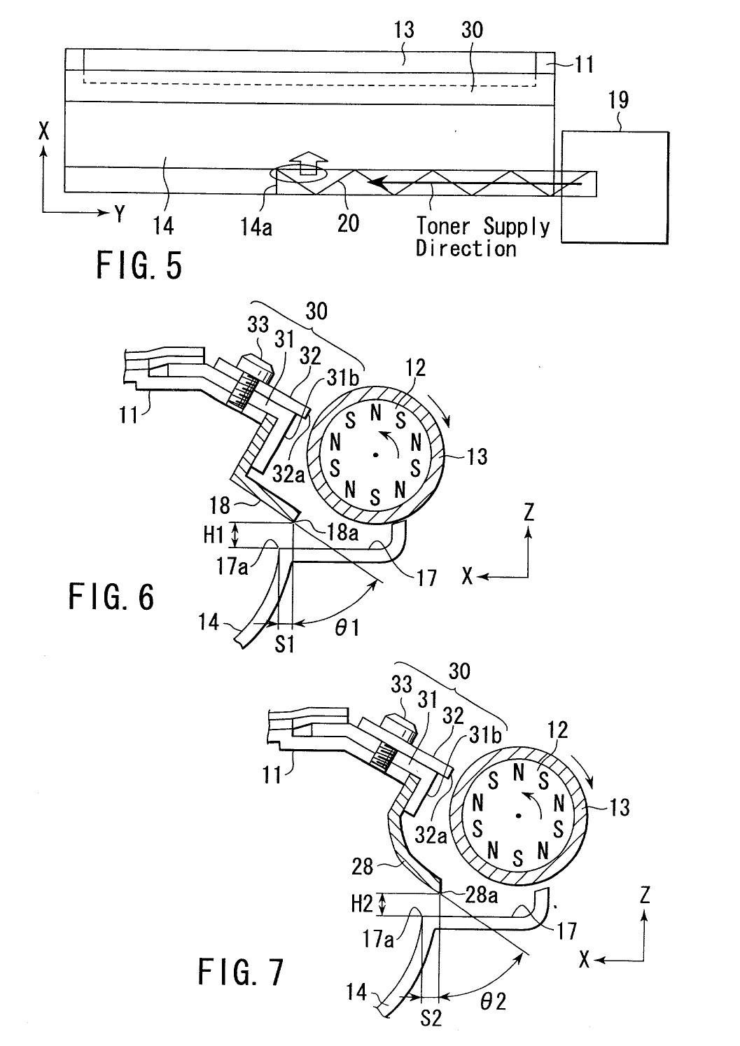

As shown in FIG. 5, a toner replenishment opening 14a is formed in an appropriate position of the toner hopper 14, and a toner cartridge of the holder 19 is connected to the toner replenishment opening 14a via an auger conveyor 20. The toner T is supplied into the toner hopper 14 from the toner cartridge of the holder 19 through the auger conveyor 20 and toner replenishment opening 14a.

When the developer (carrier/toner) starts moving, the start agent obtained by mixing the carrier and toner beforehand is supplied to the housing 11, and only the toner is subsequently supplied at a time of toner replenishment. The sensor 21 is attached to an appropriate position of the toner hopper 14, and senses an amount of the toner T present in the toner hopper 14. Additionally, as the toner, a magnetic toner having an average particle diameter of 9 μm and having magnetic properties imparted by mixing a magnetic material is used. Moreover, as the carrier, an Mn—Mg (ferrite) based magnetic carrier having an average particle diameter of 65 μm is used.

The toner hopper 14 has a semispherical bowl shape. The agitator 15 is disposed in the toner hopper 14. The agitator 15 extends in parallel to an axial line (Y axis) of a rotation center of the developing sleeve 13 and in a radial direction crossing at right angles to the axial line, and includes an arm 15b slightly shorter than a radius (inner diameter) of the toner hopper 14. Moreover, the agitator 15 is disposed on a rotating/driving shaft 15a, and has a film portion 15d slightly longer (by about 2 mm) than the radius (inner diameter) of the toner hopper 14.

The agitator arm 15b is connected to and supported by the rotating/driving shaft 15a, and has a toner carrying portion 15c on a tip end thereof. The arm 15b is formed of an acrylonitrile butadiene styrene resin (ABS resin), polycarbonate, or a composite material which contains glass fibers or glass particles in the resin.

Additionally, the rotating/driving shaft 15a of the agitator is positioned below a rotating/driving shaft 13a of the developing sleeve as seen on a Z-axis coordinate. Moreover, in the present embodiment, the agitator 15 is rotated in the same direction as a rotation direction of the magnet roller 12 (a counterclockwise direction in FIG. 4). Furthermore, a flexible sheet is attached to the tip end of the toner carrying portion 15c, so that the toner T may be carried by the flexible sheet.

The toner table 17 is used to increase an attached amount of the toner carried by the agitator 15 onto the developing sleeve 13 when the toner is attached to the peripheral surface of the developing sleeve 13 below the developing sleeve 13.

That is, a housing step 11a which connects a portion of the housing 11 covering the developing sleeve 13 (positioned below the developing sleeve 13) to the toner hopper 14 functions as the toner table 17 which temporarily holds the toner T carried by the agitator 15.

Elevation (height level) of the toner table 17 is lower than a center of the rotation shaft 15a of the agitator 15 disposed in the toner hopper 14. Moreover, a horizontal length of the toner table 17 is equal to or shorter than a diameter of the developing sleeve 13. In the present embodiment, the elevation of the toner table 17 is set to −5 mm. That is, the toner table 17 is positioned 5 mm below a lowermost portion of the developing sleeve 13. In other words, the toner table 17 is positioned 2 mm below the center of the agitator rotation shaft 15a. Moreover, the horizontal length of the toner table 17 was set to 17 mm in the present embodiment.

A developer movement control assembly 30 of the first embodiment will next be described with reference to FIG. 6.

The developing rollers 12, 13 and developer movement control assembly 30 are disposed in an upper opening of the housing 11. The developer movement control assembly 30 controls movement of the developer (carrier and toner) in the developing unit. The assembly is attached to a frame of the housing 11 so as to be in close vicinity to the developing rollers 12, 13 in a position in which interference with a rotation track of the agitator tip end 15c does not occur.

The developer movement control assembly 30 includes the developer returning member 18, doctor bracket 31, doctor blade 32, and bolt 33. The bolt 33 is inserted through an elongated hole of the doctor blade 32, and the doctor bracket 31 having a screw hole is fixed to the housing 11.

The doctor bracket 31 has an L-shaped section, and the developer returning member 18 is supported by a bent end 31b of the bracket. When the bolt 33 is loosened, and the doctor blade 32 is slid backwards and forwards, the doctor blade 32 is attached to or detached from the developing sleeve 13 and the position of the blade can thus be changed.

A tip end 32a of the doctor blade 32 is positioned in close vicinity to the outer peripheral surface of the developing sleeve 13 so that an interval between the tip end 32a and the developing sleeve 13 is about 0.25 mm at minimum. The doctor blade 32 removes the surplus toner T from the developing sleeve 13, so that a developer layer formed on the outer peripheral surface of the developing sleeve 13 has a desired thickness.

The developer returning member 18 is disposed on a downstream side from the doctor blade 32 in a developer movement direction of the sleeve 13. The developer returning member 18 prevents the toner T cut/removed from the sleeve 13 by the doctor blade 32 from dropping into the toner hopper 14, and has a function of returning the cut/removed toner T to the toner table 17.

The developer returning member 18 has an L-shaped section, and extends from end to end of the developing rollers 12, 13 along the developing rollers 12, 13. A tip end 18a (point 1) of the developer returning member 18 is positioned above the toner table 17, and the tip end 18a (point 1) is positioned toward the developing rollers 12, 13 from the boundary 17a (point 2) of the toner table 17 and toner hopper 14. That is, the tip end 18a (point 1) of the developer returning member deviates onto the right side in FIG. 6 by a distance S1 in an X-axis direction from the boundary 17a (point 2). The shift distance S1 is preferably set to a range of 0 to 10 mm, most preferably 3 to 6 mm. In the present embodiment the shift distance S1 was set to 4 mm.

Moreover, the tip end 18a (point 1) of the developer returning member is positioned to be higher than the toner table 17 by an interval H1. The interval Hi is preferably in a range of 3 to 10 mm, most preferably 4 to 8 mm. In the present embodiment, the interval Hi was set to 5 mm. The toner T is supplied to the toner table 17 and developing sleeve 13 from the toner hopper 14 through the interval Hi by the agitator 15.

Furthermore, a bent portion of the developer returning member 18 is inclined toward the toner table 17 by an angle θ1 with respect to Z-axis (vertical axis). An inclination angle θ1 is preferably in a range of 0° to 90°, most preferably 30° to 60°. The inclination angle θ1 was set to 50° in the present embodiment.

Furthermore, the developer returning member 18 is preferably formed of a material by which the carrier and toner T do not cause any frictional charging, an acrylonitrile butadiene styrene (ABS) resin, polycarbonate, or a composite material which contains glass fibers or glass particles in the resin. In the present embodiment the developer returning member 18 was formed of a glass fibers containing ABS resin.

The developer movement control assembly 30 of a second embodiment will next be described with reference to FIG. 7. Additionally, description of a redundant part of the present embodiment with respect to the aforementioned embodiment will be omitted.

The developer movement control assembly 30 of the present embodiment has a developer returning member 28 whose sectional shape is curved in a J shape. A tip end 28a (point 1) of the developer returning member 28 is positioned above the toner table 17, and the tip end 28a (point 1) deviates toward the developing rollers 12, 13 from the boundary 17a (point 2) of the toner table 17 and toner hopper 14. That is, the tip end 28a (point 1) of the developer returning member deviates on the right side from the boundary 17a (point 2) by a distance S2 in an X-axis direction in FIG. 7. The shift distance S2 is preferably in a range of 0 to 10 mm, most preferably 3 to 6 mm. The shift distance S2 was set to 5 mm in the present embodiment.

Moreover, the tip end 28a (point 1) of the developer returning member is positioned to be higher than the toner table 17 by an interval H2. The interval H2 is preferably in a range of 3 to 10 mm, most preferably 4 to 8 mm. In the present embodiment the interval H2 was set to 7 mm. The toner T is supplied to the toner table 17 and developing sleeve 13 from the toner hopper 14 through the interval H2 by the agitator 15.

Furthermore, a bent portion of the developer returning member 28 is inclined toward the toner table 17 by an angle θ2 with respect to the Z-axis (vertical axis). The inclination angle θ2 is preferably in a range of 0° to 90°, most preferably 30° to 60°. In the present embodiment the inclination angle θ2 was set to 45°.

Additionally, in the aforementioned embodiment, the developer returning member has an L or J-shaped transverse section, but the present invention is not limited to this, and the developer returning member may have a U-shaped or semicircular transverse section.

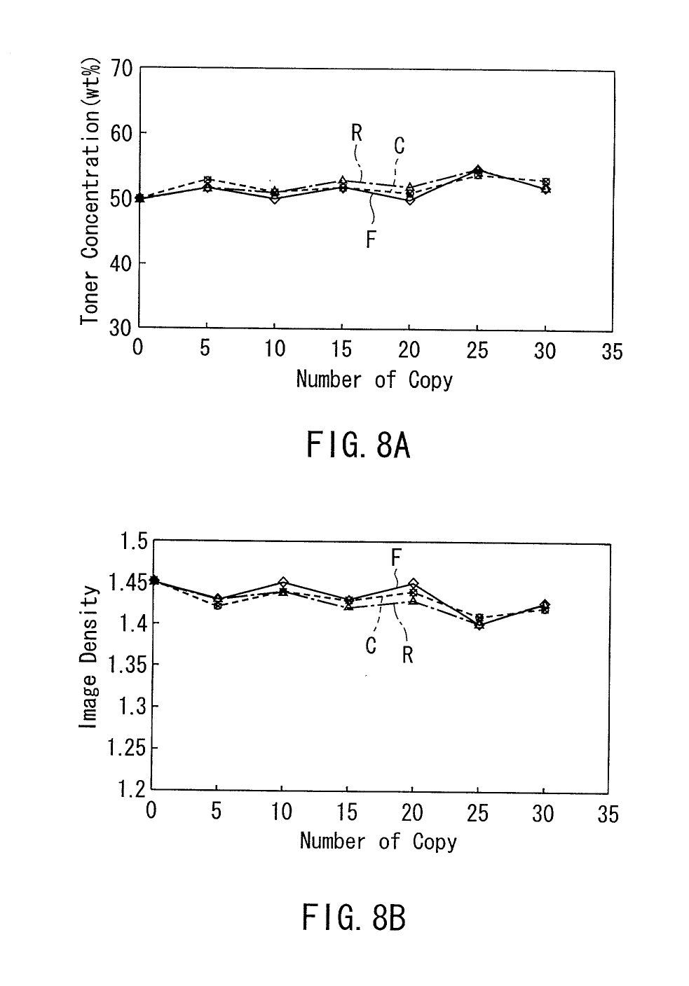

FIG. 8A is a characteristic diagram showing a toner concentration distribution with the number of copy sheets on the abscissa and a toner concentration (wt %) on the developing sleeve on the ordinate, when the apparatus of the present embodiment was used to conduct a sheet passing test. FIG. 8B is a characteristic diagram showing an image density distribution with the number of copy sheets on the abscissa and an image density (by no unit) on a hardcopy on the ordinate, when the apparatus (apparatus having the developer returning member 18) of the present embodiment was used to conduct the sheet passing test. Moreover, the toner concentration on the developing sleeve 13 was measured using a carbon amount analysis apparatus. Furthermore, the image density on the hardcopy was measured using a Macbeth densitometer.

In the diagrams a characteristic line F shows a concentration/density measurement result of a front portion (portion in the vicinity of one end of the developing sleeve 13) of the hardcopy, a characteristic line C shows a concentration/density measurement result of a center portion (middle portion of the developing sleeve 13) of the hardcopy, and a characteristic line R shows a concentration/density measurement result of a rear portion (portion in the vicinity of the other end of the developing sleeve 13) of the hardcopy. As apparent from FIG. 8A, it has been confirmed that the toner concentration on the developing sleeve 13 has only a small dispersion in each portion and with the number of passed sheets. Moreover, as apparent from FIG. 8B, it has also been confirmed that the image density on the hardcopy has only a small dispersion in each portion and with the number of passed sheets. It has been confirmed that both the toner concentration on the developing sleeve and the image density on the hardcopy are stable in this manner, and that drawbacks such as image density unevenness, image density dispersion, image density reduction, and fog are not generated in the apparatus of the present embodiment.

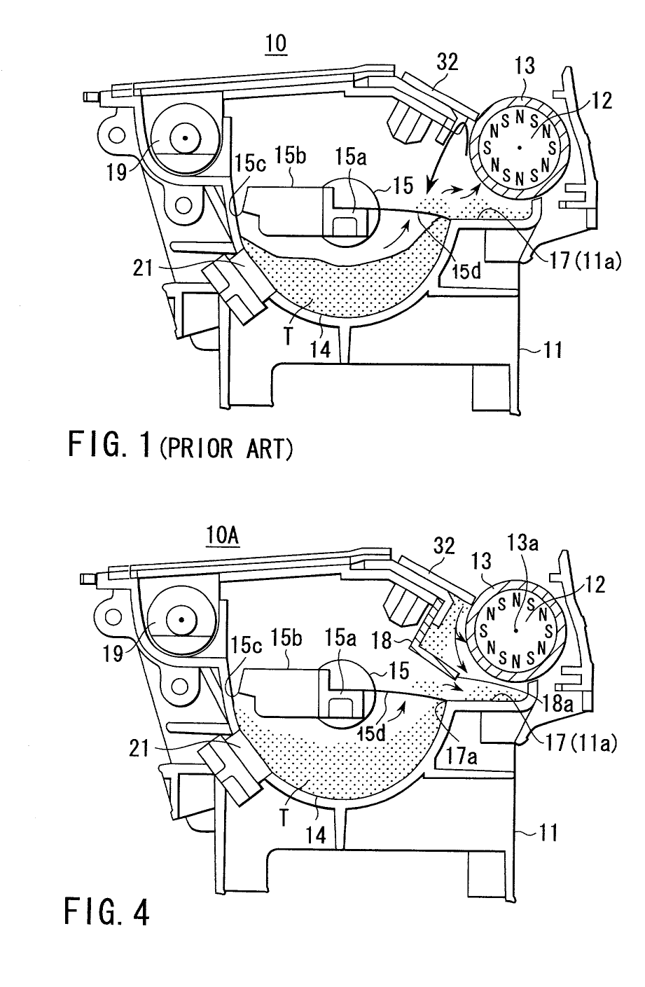

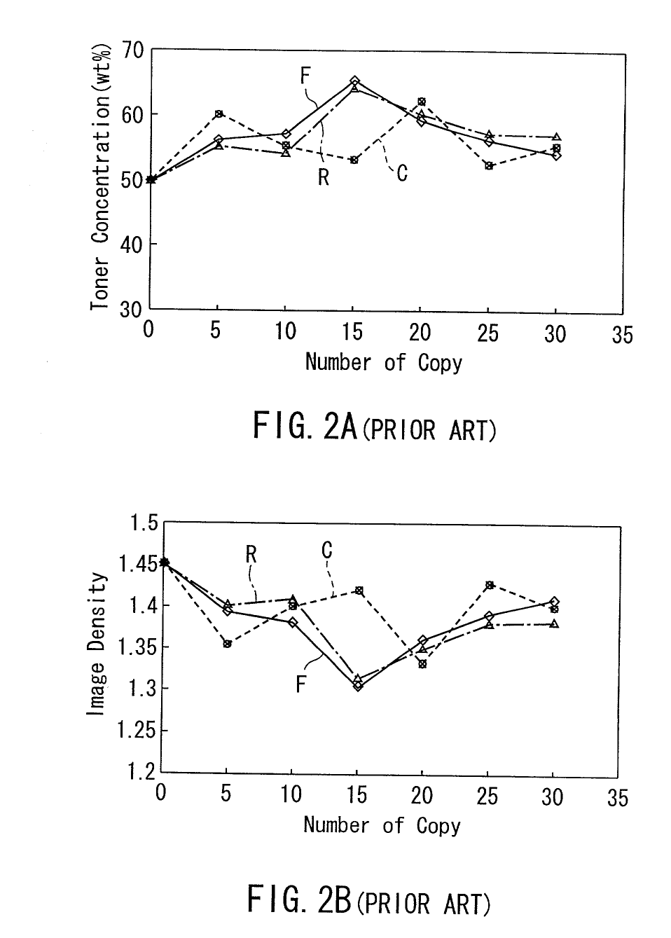

On the other hand, FIG. 2A shows the measurement result of the toner concentration on the developing sleeve, when the conventional apparatus shown in FIG. 1 (apparatus which does not have the developer returning member 18) was used to conduct the sheet passing test. FIG. 2B shows the measurement result of the image density on the hardcopy, when a similar sheet passing test was conducted. As apparent from FIGS. 2A, 2B, both the toner concentration on the developing sleeve and the image density on the hardcopy had a large dispersion, and the drawbacks such as the image density unevenness, image density dispersion, image density reduction, and fog were generated in the conventional apparatus. Additionally, it has been seen that a mixture ratio (T/C) of the toner to the magnetic carrier largely fluctuated in a range of 30 to 80% in the conventional apparatus, but was stable at about 50% on average in the apparatus of the present invention.

As described above, according to the present invention, the surplus developer (carrier, toner) cut by the doctor blade can securely be guided to the developing sleeve and toner table by the developer returning member, and the toner concentration unevenness (dispersion) of the developer on the developing sleeve does not easily occur. According to the image forming apparatus of the present invention, a stable image having no drawbacks such as the image density unevenness, image density dispersion, image density reduction, and fog can be obtained over a long period.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming apparatus comprising: image reading means for reading an image; a photosensitive drum on which an electrostatic latent image corresponding to said image is formed based on image data given from the image reading means; a vertical conveyance path along which a transfer sheet is conveyed upwards to the photosensitive drum; and a developing device which is disposed below said photosensitive drum and which uses a small amount of magnetic carrier to allow a toner to be adsorbed onto the electrostatic latent image on said photosensitive drum,
wherein said developing device comprises:
a toner hopper which contains the toner;
a toner supply source which supplies the toner to the toner hopper;
a toner table which is disposed in a position higher than a position of said toner hopper, which has a boundary adjacent to said toner hopper, and on which the toner is laid;
an agitator which is disposed in said toner hopper, agitates/mixes the contained toner, and carries the toner to said toner table from said toner hopper;
a magnet roller disposed above said toner table;
a developing sleeve which covers an outer periphery of the magnet roller, holds said magnetic carrier, allows the toner of said toner table to be adsorbed onto the magnetic carrier, is rotated/driven in a direction reverse to a rotating/driving direction of said magnet roller, and shifts and attaches said toner to said electrostatic latent image of said photosensitive drum;
a doctor blade which has a tip end disposed close opposite to said developing sleeve at a predetermined interval, and whose tip end cuts/removes a surplus toner from said developing sleeve; and
a developer returning member which is disposed between said developing sleeve and said toner hopper and is positioned in a position higher than a position of said toner table to prevent the toner cut/removed by said doctor blade from dropping toward said toner hopper and to return the cut/removed toner to said toner table, and which has a tip end displaced toward said developing sleeve from the boundary of said toner table and said toner hopper to form a space for carrying the toner by said agitator between the tip end and said toner table.

2. The apparatus according to claim 1, wherein said developer returning member is positioned below said doctor blade.

3. The apparatus according to claim 1, wherein the tip end of said developer returning member is inclined in a range of 0° to 90° with respect to a vertical line.

4. The apparatus according to claim 1, wherein the tip end of said developer returning member is inclined in a range of 30° to 60° with respect to a vertical line.

5. The apparatus according to claim 1, wherein said developer returning member has an L-shaped or J-shaped transverse section.

6. The apparatus according to claim 1, wherein said developer returning member is formed of a material by which the magnetic carrier and the toner do not cause any frictional charging.

7. The apparatus according to claim 6, wherein said developer returning member is formed of an ABS resin, polycarbonate, or a composite material which contains glass fibers or glass particles in the resin.

8. A developing device for use in an image forming apparatus, comprising:
a toner hopper which contains a toner;
a toner supply source which supplies the toner to the toner hopper;
a toner table which is disposed in a position higher than a position of said toner hopper, which has a boundary adjacent to said toner hopper, and on which the toner is laid;
an agitator which is disposed in said toner hopper, agitates/mixes the contained toner, and carries the toner to said toner table from said toner hopper;
a magnet roller disposed above said toner table;
a developing sleeve which covers an outer periphery of the magnet roller, holds said magnetic carrier, allows the toner of said toner table to be adsorbed onto the magnetic carrier, is rotated/driven in a direction reverse to a rotating/driving direction of said magnet roller, and shifts and attaches said toner onto an electrostatic latent image of a photosensitive drum;
a doctor blade which has a tip end disposed close opposite to said developing sleeve at a predetermined interval, and whose tip end cuts/removes a surplus toner from said developing sleeve; and
a developer returning member which is disposed between said developing sleeve and said toner hopper and is positioned in a position higher than a position of said toner table to prevent the toner cut/removed by said doctor blade from dropping toward said toner hopper and to return the cut/removed toner to said toner table, and which has a tip end displaced toward said developing sleeve from the boundary of said toner table and said toner hopper to form a space for carrying the toner by said agitator between the tip end and said toner table.
